(19) United States
(12) Patent Application Publication
(10) Pub. No.: US 2024/0370478 A1
(43) Pub. Date: Nov. 7, 2024

(54) RECURSIVE DATA ANALYSIS THROUGH AUTOMATED DATABASE QUERY GENERATION

(71) Applicant: Navan, Inc., Palo Alto, CA (US)

(72) Inventors: Ilan Ezra Twig, San Francisco, CA (US); Noy Factor, Givatayim (IL); Natalie Zayats, Mountain View, CA (US)

(21) Appl. No.: 18/656,490

(22) Filed: May 6, 2024

Related U.S. Application Data
(60) Provisional application No. 63/500,204, filed on May 4, 2023.

(51) Int. Cl. G06F 16/33

(52) U.S. Cl. CPC G06F 16/3344

(57) ABSTRACT

An online system performs a recursive process for analyzing data using an LLM. The online system receives an initial analysis prompt from a user's client device. The online system repeatedly retrieves data from a database of the online system that can be useful for answering the prompt provided by user's analysis prompt. In one of these iterations, the online system generates a recursive prompt for an LLM of a model serving system and generates database queries that correspond to these generated text prompts. The online system can thereby apply these dynamically-generated database queries to its database to retrieve data to answer the generated text prompts. The online system repeatedly performs this process until an end condition is met. The online system generates a final prompt based on the retrieved data, the generated prompts, and the initial analysis prompt, and receives the prompted analysis from the model serving system.

This application claims the benefit of U.S. Provisional Application No. 63/500,204, entitled “Recursive Data Analysis through Automated Database Query Generation” and filed May 4, 2023, which is incorporated by reference.

### BACKGROUND

An online system may store data on behalf of a third-party entity in a database as part of providing a service to the third-party entity. The third-party entity may want analytics to be performed on their data and provided to them as part of the service by the online system. For example, the online system may provide a support chat function and may allow a third-party entity to request analytics to be performed on their data through the support chat function.

Certain basic analysis can be performed through a simple mapping of a user's request to generic analytical processes the online system can perform. For example, if a user wants the system to output an average value for a metric over a period of time, the online system may map certain keywords in the user's request (e.g., “average”) and determine the operation to perform based on those keywords. However, a user may request analytics that go beyond ones that the online system is configured to automatically perform. For example, the user may request that analytics be performed that are specific to the user's data. In these situations, the online system may either not respond to the entity's request or may have a human operator perform the analytics. The former option provides an unsatisfactory experience to the entity and the latter may require a lot of human labor and time to perform.

Some systems may use large language models (LLMs) to assist with data analysis on large sets of data. However, LLMs generally have two limitations that constrain their applicability to data analytics. First, LLMs suffer from the “hallucination problem” where they generate output that seems correct but is actually false. Second, LLMs generally have a context window that limits how much information can be analyzed by the LLM in one pass. Therefore, LLMs tend to be limited in their ability to analyze large amounts of data.

### SUMMARY

An online system performs a recursive process for analyzing data using an LLM. The online system receives an initial analysis prompt from a user's client device. This analysis prompt is a free text prompt from the user requesting analytics of data stored by the online system. For example, the free text prompt may request that the online system identify ways for the online system to more effectively optimize the allocation of computing resources to different tasks in the online system.

The data stored by the online system can be useful for responding to the user's prompt, but there may be too much data for an LLM to process in a single context window. Accordingly, the online system performs a recursive process whereby the online system breaks down the analysis into simpler questions, retrieves data to answer those simpler questions, and builds back up to the more complicated question presented in the user's prompt.

To perform this recursive process, the online system repeatedly retrieves data from a database of the online system that can be useful for answering the prompt provided by user's analysis prompt. In one of these iterations, the online system generates a recursive prompt for an LLM of a model serving system. This recursive prompt is a prompt for an LLM that requests that the LLM of the model serving system generate a set of text prompts that request additional data for answering the initial analysis prompt. For example, where the initial prompt requests suggestions for how to improve computing resource allocation, the set of text prompts may include requests for average usage of different computing resources or minimum or maximum usages for different computing resources.

The online system generates database queries that correspond to these generated text prompts. The database queries are queries (e.g., SQL queries) for data from the online system's database that retrieve the data needed to answer the generated text prompt. For example, where a text prompt asks for a minimum resource usage of a particular resource, the corresponding database query may be a query for resource usage values over time or simply a minimum value of a set of resource usage values for that resource. The online system may generate these database queries based on similar example prompts and database queries. The online system can thereby apply these dynamically-generated database queries to its database to retrieve data to answer the generated text prompts, which will aid in answering the initial analysis prompt from the user.

The online system repeatedly performs this process until an end condition is met. For example, the online system may perform the process for a certain number of iterations or until the user instructs the online system to stop the process. The online system generates a final prompt based on the retrieved data, the generated prompts, and the initial analysis prompt. This final prompt instructs the model serving system to generate the requested analytics. The online system receives this analysis from the model serving system and provides the analysis to the user through the client device accordingly.

By performing the recursive process, the online system addresses the constraints on LLMs described above. Specifically, by limiting the data being analyzed by the online system to the data that was actually helpful in answering the user's initial prompt, the online system ensures that the data provided to the LLM fits within the context window of the LLM. Furthermore, by breaking down the original question into the generated sub-prompts, the online system simplifies the analysis required by the LLM, which reduces the likelihood that the LLM will hallucinate.

### BRIEF DESCRIPTION OF THE DRAWINGS

FIG. 1 illustrates an example system environment for an online system, in accordance with some embodiments.

FIG. 2 is an interaction diagram illustrating an example method by which an online system generates database queries using a model serving system, in accordance with some embodiments.

FIG. 3 is an interaction diagram illustrating an example method by which an online system recursively prompts a model serving system for data analysis, in accordance with some embodiments.

FIG. 4 illustrates a set of example prompt examples, in accordance with some embodiments.

FIG. 5 illustrates an example data flow for generating a new database query based on a free text prompt, in accordance with some embodiments.

FIG. 6 illustrates an example data flow for a process of generating an analysis response using a recursive analysis process, in accordance with some embodiments.

### DETAILED DESCRIPTION

### System Environment

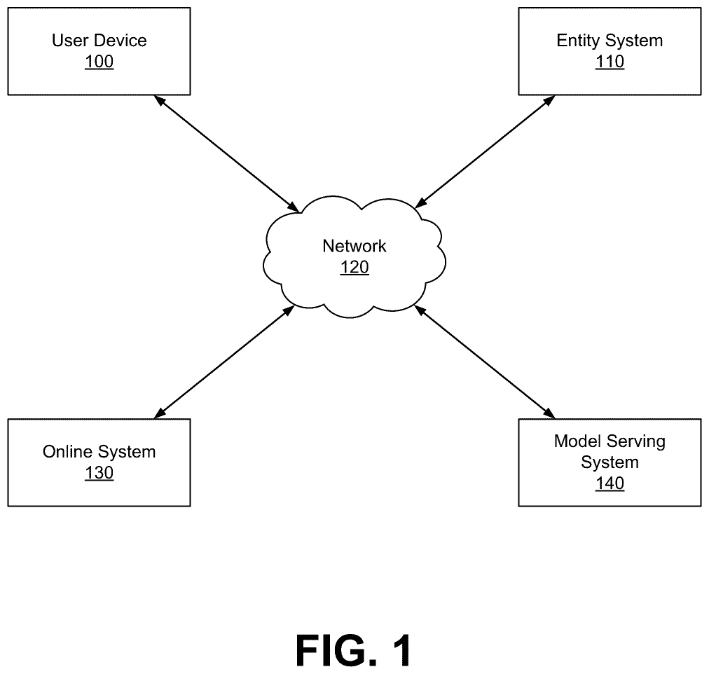

Figure (FIG. 1 illustrates an example system environment for an online system 130, in accordance with some embodiments. The system environment illustrated in FIG. 1 includes a user device 100, an entity system 110, a network 120, an online system 130, and a model serving system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

A user can interact with other systems through a user device 100. The user device 100 can be a personal or mobile computing device, such as a smartphone, a tablet, a laptop computer, or desktop computer. In some embodiments, the user device 100 executes a client application that uses an application programming interface (API) to communicate with other systems through the network 120.

The entity system 110 is a computing system operated by an entity. The entity may be a business, organization, or government, and the user may be an agent or employee of the entity.

The network 120 is a collection of computing devices that communicate via wired or wireless connections. The network 120 may include one or more local area networks (LANs) or one or more wide area networks (WANs). The network 120, as referred to herein, is an inclusive term that may refer to any or all of standard layers used to describe a physical or virtual network, such as the physical layer, the data link layer, the network layer, the transport layer, the session layer, the presentation layer, and the application layer. The network 120 may include physical media for communicating data from one computing device to another computing device, such as MPLS lines, fiber optic cables, cellular connections (e.g., 3G, 4G, or 5G spectra), or satellites. The network 120 also may use networking protocols, such as TCP/IP, HTTP, SSH, SMS, or FTP, to transmit data between computing devices. In some embodiments, the network 120 may include Bluetooth or near-field communication (NFC) technologies or protocols for local communications between computing devices. Similarly, the network 120 may use phone lines for communications. The network 120 may transmit encrypted or unencrypted data.

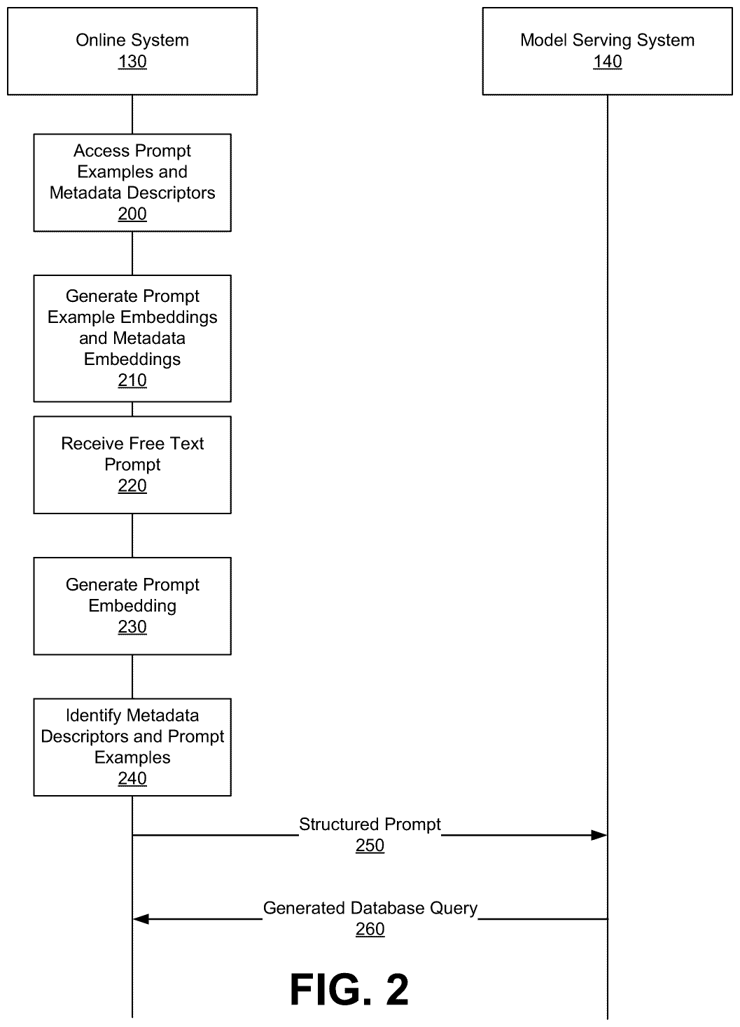

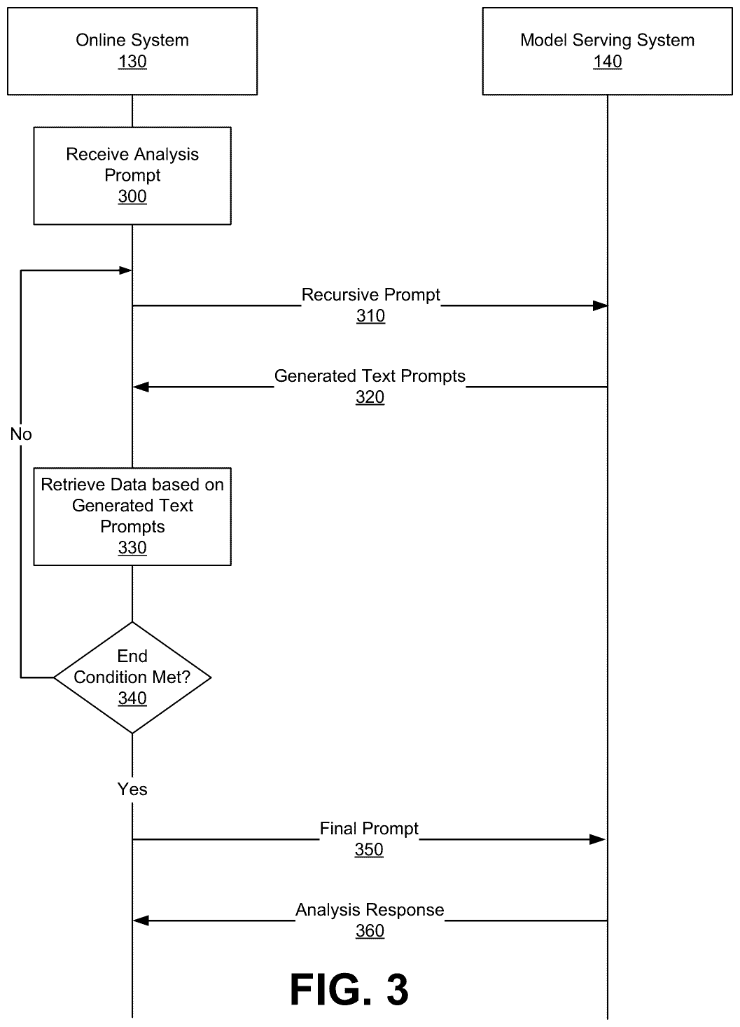

The online system 130 stores information for entities in databases. The online system 130 may have a database for each entity and may store transaction information for the entity in their corresponding database. The online system 130 also may provide a support chat interface through which a user corresponding to an entity can request information on the entity's data stored by the online system 130. For example, the user device 100 may present a chat interface from the online system 130 to the user and the user may use the chat interface to request information from the online system 130. The online system 130 automatically provides answers to the user's request. Example methods for answering a user's request for information are described in further detail below with regards to FIGS. 2 and 3.

The model serving system 140 receives requests from other systems to perform tasks using machine-learned models. The tasks include, but are not limited to, natural language processing (NLP) tasks, audio processing tasks, image processing tasks, video processing tasks, and the like. In one embodiment, the machine-learned models deployed by the model serving system 140 are models configured to perform one or more NLP tasks. The NLP tasks include, but are not limited to, text generation, query processing, machine translation, chatbots, and the like. In one embodiment, the language model is configured as a transformer neural network architecture. Specifically, the transformer model is coupled to receive sequential data tokenized into a sequence of input tokens and generates a sequence of output tokens depending on the task to be performed.

The model serving system 140 receives a request including input data (e.g., text data, audio data, image data, or video data) and encodes the input data into a set of input tokens. The model serving system 140 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens may be arranged as a tensor with one or more dimensions, for example, one dimension, two dimensions, or three dimensions. In an example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 130 or one or more entities different from the online system 130. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

While the model serving system 140 is depicted as separate from the online system 130 in FIG. 1, in alternative embodiments, the model serving system 140 is a component of the online system 130.

Though the system can be applied in many environments, in one example, the online system 130 is an expense management system. An expense management system is a computing system that manages expenses incurred for an entity by users. An example system is described in further detail in U.S. patent application Ser. No. 18/487,821 filed Oct. 16, 2023, which is incorporated by reference.

In embodiments where the online system is an expense management system, the online system may use a recursive data analysis process to perform analyses of an entity's expenses through the online system. For example, a user associated with an entity may use a chatbot interface to ask the online system questions about how to reduce an amount of consideration output due to user interactions with the online system. The recursive process described in further detail below.

### Example Method for Generating Database Queries

FIG. 2 is an interaction diagram illustrating an example method by which an online system generates database queries using a model serving system, in accordance with some embodiments. Some embodiments may have more, fewer or different steps from those illustrated in FIG. 2, and the steps may be performed in a different order from that illustrated. Additionally, the steps may be performed by different entities or systems from those illustrated and the functionality may be divided between the systems differently from FIG. 2. For example, as noted above, the model serving system may be part of the online system.

The online system accesses 200 a set of prompt examples stored by the online system. A prompt example represents an example of how the model serving system should generate a response based on a particular input. Specifically, each prompt example includes an example free text prompt and an example output from the model serving system 140 to be generated based on that free text prompt. The free text prompts in the prompt examples are free text describing a request for data stored by the online system. For example, a free text prompt may be a request for data describing interactions performed by users with the online system, actions performed by devices within a network, or inputs to or outputs from application workflows of applications operating on the online system. In some cases, the free text prompt of a prompt example requests for processed data from the online system, rather than simply raw data that might not require additional calculations. For example, the free text prompt may ask for the total number of user interactions with the online system within the last three months or an average value for an output of an application workflow.

As noted above, each prompt example also includes an example output for the model serving system to generate for each of the free text prompts. These example outputs may include a database query. The database query of a prompt example is an instruction to be applied to a database to collect data from the database. The database query specifies what data to collect and from where in the database. In some embodiments, the database query is a Structured Query Language (SQL) query to be performed on the database. Each database query for a prompt example is a query to collect data requested by the free text prompt of the corresponding prompt example. For example, if the free text prompt contains the free text “Please provide a list of all interactions taken by this set of users,” the database query may be a SQL query that requests interaction within a user interaction database of the online system. In some embodiments, where the free text prompt requests processed data from the online system, the database query is a query that requests the data necessary to generate the processed data. For example, if the free text prompt requests an average value output by an application workflow, the database query may request the values for outputs of an application workflow and the online system may compute the average based the prices collected from a database using the database query. In some cases, a prompt example may include more than one database query. The multiple database queries in a prompt example may include queries to different databases or may query different data sets from the same database.

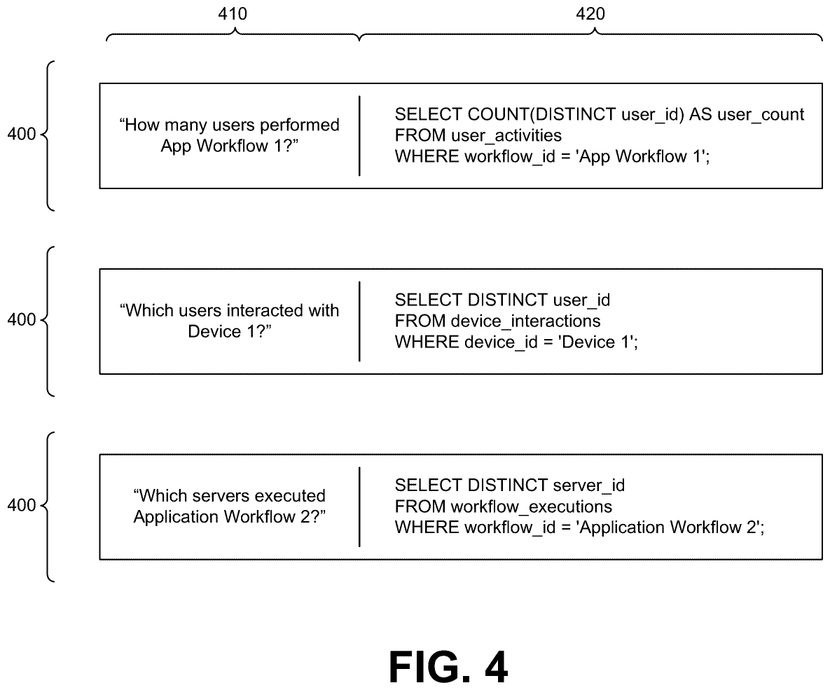

FIG. 4 illustrates a set of example prompt examples 400, in accordance with some embodiments. Each prompt example includes an example free text prompt 410 and a database query 420 that corresponds to the free text example.

The online system also accesses 200 metadata descriptors for a database. A metadata descriptor describes what data is stored in a database. For example, for a database that stores information describing user interactions with an online system, metadata descriptors may indicate that the database stores timestamps of user interactions, user identifiers for user interactions, type identifiers for the user interactions, or content associated with the user interactions. In some embodiments, metadata descriptors are the names of field identifiers or columns within the database. For example, if the database has an “INTERACTION_TYPE” field name, the metadata descriptors for the database may simply be “INTERACTION_TYPE.” In some embodiments, each metadata descriptor includes a free text description of the metadata descriptor. For example, the example “INTERACTION_TYPE” metadata descriptor may include a free text description explaining that “INTERACTION_TYPE is an integer identifier for a type of interaction.” In some embodiments, each entity using the online system is associated with a different set of metadata descriptors. For example, the online system may store different data for different entities, and thus may store metadata descriptors corresponding to each entity.

The online system generates 210 embeddings for the prompt examples and the metadata descriptors. The prompt example embeddings and the metadata descriptor embeddings are in the same latent space, thus prompt example embeddings that are close to metadata descriptor embeddings represent prompt examples and metadata descriptors that are similar to each other. In some embodiments, the prompt example embeddings are generated based on the free text prompts of the prompt examples and not the database queries of the prompt examples. The online system may pre-generate the prompt example embeddings and the metadata descriptor embeddings and access the pre-generated embeddings in response to receiving a free text prompt from a user.

The online system may generate the prompt example embeddings and the metadata embeddings using an embedding model. The online system may use a separate embedding models for each type of embedding or may use a joint embedding model that generates the prompt example embeddings and the metadata descriptor embeddings. In some embodiments, the online system uses an embedding model of the model serving system to generate the embeddings for the prompt examples and the metadata descriptors. The embedding model may include a large language model (LLM) that can generate embeddings for prompt examples or metadata descriptors.

The online system receives 220 a free text prompt from a user. The free text prompt describes a request for data stored by the online system. For example, the free text prompt may request the average output values from application workflows executed by the online system or a list of application workflows that were executed within a time period. Like the prompts in the prompt examples, the free text prompt may request raw data stored directly by the database or may request information requiring some processing of the stored data.

In some embodiments, the online system determines whether the free text prompt corresponds to a prompt of a prompt example. For example, the online system may compare the embeddings for each of the prompt examples to an embedding generated based on the free text prompt. In some embodiments, the online system computes a comparison score (e.g., a dot product or a cosine similarity) of the embeddings. If the comparison score between the free text prompt and a prompt example exceeds some threshold, the online system may determine that the received free text prompt corresponds to the prompt example and may simply use the corresponding database query for the prompt example as the output for the free text prompt. However, if the free text prompt does not correspond to a prompt example or if the online system does not determine whether the free text prompt corresponds to a prompt example, the online system generates a database query for the free text prompt.

To generate the database query, the online system generates 230 a prompt embedding for the free text prompt (e.g., using the same embedding model used to generate the embeddings of the prompt examples), and identifies 240 metadata descriptors and prompt examples that are similar to the free text prompt based on the generated embeddings for the metadata descriptors, prompt examples, and free text prompt. For example, the online system may compare the prompt embedding for the free text prompt to the metadata embeddings and the prompt example embeddings to generate similarity scores representing the similarity of the prompt embedding to the other embeddings. In some embodiments, the online system computes the similarity score by computing the distance between embeddings, a dot product of the embeddings, or the cosine similarity of the embeddings. The online system may identify a set of metadata descriptors and prompt examples with similarity scores that exceed some threshold or may identify metadata descriptors or prompt examples with the top n similarity scores, for some number n.

The online system generates a structured prompt 250 based on the free text prompt from the user and the identified metadata descriptors and prompt examples and transmits the structured prompt 250 to the model serving system. The structured prompt is a text prompt that requests that the model serving system generate text corresponding to a database query to be applied to a database of the online system for data needed to respond to the free text prompt from the user. The structured prompt includes the free text prompt from the user and the identified metadata descriptors describing the data in the database to which the database query will be applied. Additionally, the structured prompt includes the free text prompts from the identified prompt examples and the database queries that correspond to those example free text prompts. The structured prompt may associate the free text prompts of the prompt examples with their corresponding database queries so that the model serving system recognizes which free text prompts correspond to which database queries.

In some embodiments, the structured prompt is generated based on a prompt template that specifies how to generate the text for the structured prompt. The prompt template includes text that explains the request for the model serving system and specifies where the free text prompt from the user, the identified metadata descriptors, and the prompt examples should be included into the template to generate the structured prompt.

The online system transmits the structured prompt 250 to the model serving system and receives a generated database query 260 from model serving system based on the structured prompt 250. The online system may use the generated database query 260 to retrieve data from the database and use the retrieved data to generate a response to the user's free text prompt. In some embodiments, the online system responds to the user's free text prompt by providing the retrieved data to the user. However, where the user's free text prompt includes an implicit or explicit request to process the retrieved data, the online system performs the requested analysis on the retrieved data. In some embodiments, the online system recursively prompts a model serving system to perform the analysis on the retrieved data.

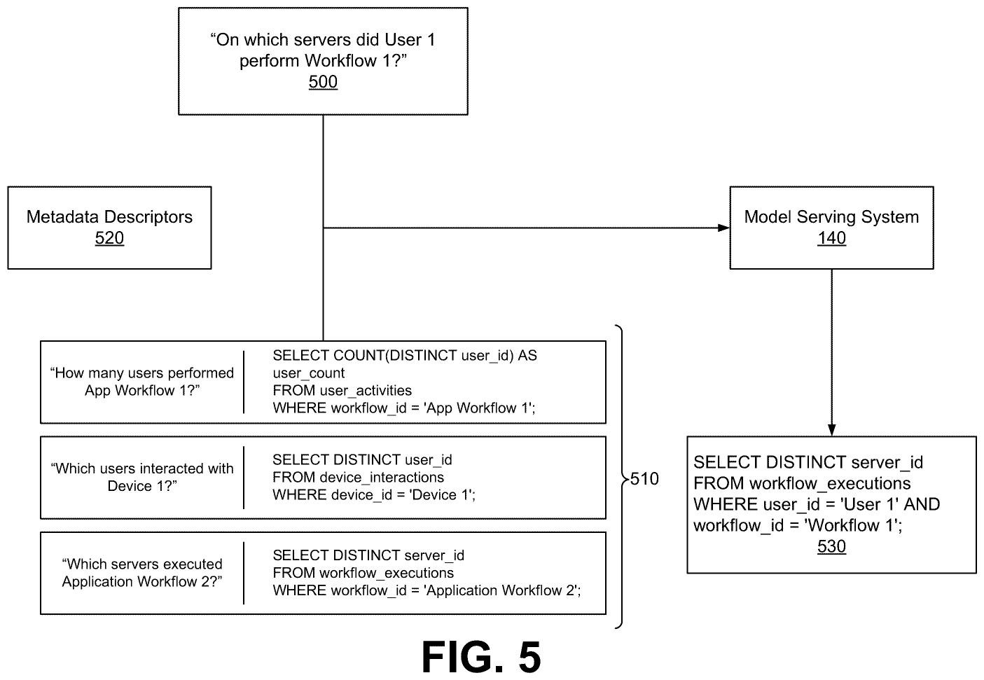

FIG. 5 illustrates an example data flow for generating a new database query 530 based on a free text prompt 500, in accordance with some embodiments. The online system receives the free text prompt 500 from a user and identifies a set of prompt examples 510 that relate to the free text prompt 500. The online system provides the free text prompt 500, the set of prompt examples 510, and a set of relevant metadata descriptors 520 to the model serving system 140 to generate the database query 530.

### Example Method for Recursively Prompting a Model Serving System for Data Analysis

FIG. 3 is an interaction diagram illustrating an example method by which an online system recursively prompts a model serving system for data analysis, in accordance with some embodiments. Some embodiments may have more, fewer or different steps from those illustrated in FIG. 3, and the steps may be performed in a different order from that illustrated. Additionally, the steps may be performed by different entities or systems from those illustrated and the functionality may be divided between the systems differently from FIG. 3. For example, as noted above, the model serving system may be part of the online system. Furthermore, while the method below is described predominantly in the context of an online system, the description is generically applicable to other online systems.

The online system receives 300 an analysis prompt from a user. The analysis prompt is free text describing a request for analytics from the online system based on data stored by the online system. For example, the analysis prompt may request that the online system identify trends in user behavior on the online system or potentially identify malicious behavior of users based on user interaction data or application workflow outputs. The online system receives the analysis prompt through a user interface displayed on the user's client device. For example, the user interface may include a chatbot interface whereby the user can input prompts to a chatbot and responses from the chatbot are displayed to the user. The online system may receive the analysis prompt as a prompt input by the user to the chatbot interface. In some embodiments, the user interface further includes UI elements whereby the user can input parameters for the recursive prompting of the model serving system.

The online system generates a recursive prompt 310 based on the analysis prompt. The recursive prompt 310 is a text prompt requesting that the model serving system generate a set of text prompts for a recursive prompting process. Specifically, the recursive prompt 310 requests that the model serving system generate text prompts that would request information from a database that would be helpful for answering the analysis prompt received from the user. For example, the recursive prompt 310 may ask the model serving system “Generate questions that one would ask to get additional information to answer the following question from a user.”

The recursive prompt 310 may include preset parameters stored by the online system or parameters provided by the user through the user interface. For example, the recursive prompt 310 may request a certain number of text prompts from the model serving system. Additionally, the recursive prompt 310 may include contextual information that the model serving system may use to generate the text prompts for the online system. For example, the recursive prompt 310 may include information on which user provided the analysis prompt or information on an entity for which the user is requesting analytics. In some embodiments, the recursive prompt 310 includes metadata descriptors describing data contained in a database.

Furthermore, the recursive prompt 310 may include role indicators that indicate a hypothetical role for the model serving system to play in generating the text prompts. The role indicator may indicate a real-world perspective for the model serving system to take in generating the text prompts for the recursive prompt. For example, the recursive prompt 310 may request that the model serving system generate the text prompts as if they were someone with a particular occupation, background, or history. The role indicators may be provided by the user through the user interface. Alternatively, the role indicator may be generated by the online system. For example, the online system may prompt the model serving system to identify a role of a person who may provide a helpful or useful perspective or expertise to answer the analysis prompt. The online system may use the model serving system's identified role as the role indicator in the recursive prompt.

In some embodiments, the online system generates the recursive prompt 310 based on a template for recursive prompts. The template may include instructions on where to include contextual information within the recursive prompt 310 and includes text that requests that the model serving system generate text prompts for questions that would help in answering the request described in the received analysis prompt.

The model serving system generates text prompts 320 as requested by the recursive prompt 310 and transmits the generated text prompts 320 to the online system. The online system receives the generated text prompts 320 and retrieves 330 data requested by the generated text prompts 320. To retrieve the requested data, the online system uses the process described above in the context of FIG. 2.

The model serving system determines 340 whether an end condition is met. The end condition is a condition that determines whether the expense management will continue requesting text prompts 320 from the model serving system. For example, the end condition may be that the online system repeats the process a certain number of times or may be that the online system retrieve a certain amount of data. In some embodiments, the end condition is that a user indicates that the online system does not need to continue retrieving data, where that user is reviewing the data retrieved by the online system based on the generated text prompts 320 in each iteration. The user may provide this indication through a user interface provided by the online system.

If the online system determines 340 that the end condition is not met, the online system repeats the process again by generating another recursive prompt 310. The newly generated recursive prompt 310 includes all of the retrieved data from previous iterations, and thus provides the context of the data from the previous generations to the model serving system when the model serving system is generated the new text prompts 320.

If the online system determines 340 that the end condition is met, the online system generates a final prompt 250 to transmit to the model serving system. The final prompt 350 is text requesting that the model serving system generate text with the analysis that was requested by the analysis prompt from the user. The final prompt 350 includes the analysis prompt from the user and the data retrieved 330 by the online system during the iterative process. The online system may generate the final prompt 350 based on a prompt template that includes a request that the model serving system generate a response with an analysis of the data retrieved by the online system. This prompt template may also indicate where the data retrieved by the expense management model, and any other contextual information for the analysis, should be included in the final prompt 350.

The model serving system transmits an analysis response 360 to the online system. The analysis response 360 comprises text that includes the analysis requested by the user in the analysis prompt. In some embodiments, the online system post-processes the received analysis response 360 to determine whether the response is sufficient to satisfy the received analysis request. For example, if the analysis request asks for a certain number of suggestions to reduce costs for an entity, the online system may evaluate the analysis response 360 to ensure that the requested number of suggestions were included.

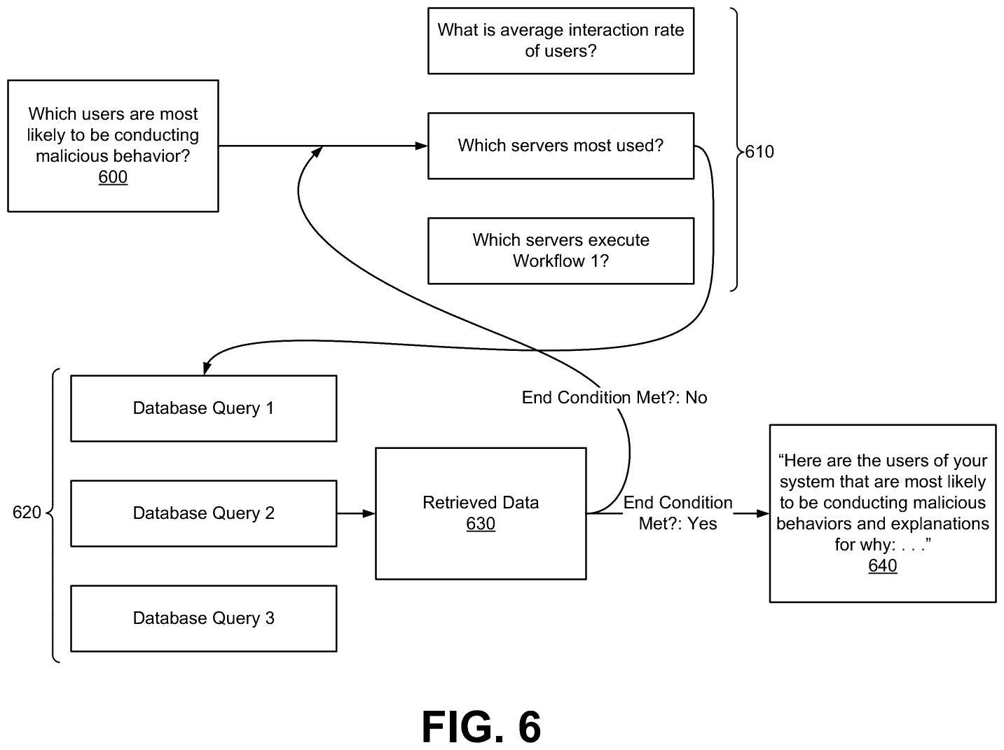

FIG. 6 illustrates an example data flow for a process of generating an analysis response using a recursive analysis process, in accordance with some embodiments. The online system receives an analysis prompt 600 and transmits a recursive prompt to the model serving system to generate a set of text prompts 610 for answering the analysis prompt 600. The online system generates a set of database queries 620 for the set of text prompts and retrieves data 630 from databases using those queries. If the end condition is not met, the online system iterates on the process by generating an additional set of text prompts 610 based on the retrieved data 630 accessed in previous iterations. If the end condition is met during one of the iterations, the online system ends the recursive process and outputs the analysis response 640 generated based on the retrieved data 630.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, at an online system, an analysis prompt from a client device of a user, wherein the analysis prompt comprises free text requesting analytics of data stored by the online system in a database;
repeatedly retrieving data from the database for performing the requested analytics by:
generating a recursive prompt based on the analysis prompt from the user, wherein the recursive prompt comprises text requesting that a model serving system generate a plurality of text prompts, wherein each text prompt comprises a request for data stored in the database, and wherein the recursive prompt comprises previously retrieved data;
transmitting the recursive prompt to the model serving system;
receiving generated text prompts from the model serving system; and
retrieving data from the database based on the generated text prompts;
responsive to determining that an end condition is met, ending the repeated retrieval of data from the database;
generating a final prompt based on the retrieved data from the database and the received analysis prompt, wherein the final prompt comprises text requesting that the model serving system generate the requested analytics;
receiving an analysis response from the model serving system comprising the requested analytics; and
transmitting the analysis response to the client device for display to the user.

2. The method of claim 1, wherein receiving the analysis prompt comprises:
receiving the analysis prompt through a user interface of a client application operating on the client device of the user.

3. The method of claim 2, wherein receiving the analysis prompt comprises:
receiving the analysis prompt through a chatbot interface of the user interface.

4. The method of claim 1, wherein the user and the database are associated with a third-party entity that is associated with data stored in the database.

5. The method of claim 1, wherein the recursive prompt comprises a role indicator indicating a real-world perspective for generating text prompts.

6. The method of claim 1, wherein retrieving data from the database based on the generated text prompts comprises:
generating a database query for each of the generated text prompts.

7. The method of claim 6, wherein generating a database query for each of the generated text prompts comprises:
accessing a set of prompt examples stored by the online system, wherein each prompt example comprises:
a free text prompt describing a request for data stored by the online system in a database; and
a database query to retrieve the data stored by the online system from the database;
generating a prompt example embedding for each prompt example of the set of prompt examples based on the free text prompt of the prompt example; and
for each of the generated text prompts:
generating a prompt embedding for the generated text prompts, wherein the prompt embedding for the generated text prompt is in the same latent space as the prompt example embeddings;
identifying prompt examples that are similar to the generated text prompt based on the prompt example embeddings and the prompt embedding for the generated text prompt;
transmitting a structured prompt to a model serving system, wherein the structured prompt comprises the generated text prompt and the database queries corresponding to the identified prompt example embeddings; and
receiving, from the model serving system, a generated database query corresponding to the generated text prompt, wherein the generated database query is a query for collecting data from the database that was requested by the generated text prompt.

8. The method of claim 1, wherein determining that the end condition is met comprises:
receiving a stop instruction from the client device of the user.

9. The method of claim 1, wherein determining that the end condition is met comprises:
determining that the repeated retrieval of data from the database has been performed a threshold number of times.

10. The method of claim 1, wherein the model serving system is a third-party system.

11. A non-transitory computer-readable medium storing instructions that, when executed by a processor, cause the processor to perform steps comprising:
receiving, at an online system, an analysis prompt from a client device of a user, wherein the analysis prompt comprises free text requesting analytics of data stored by the online system in a database;
repeatedly retrieving data from the database for performing the requested analytics by:
generating a recursive prompt based on the analysis prompt from the user, wherein the recursive prompt comprises text requesting that a model serving system generate a plurality of text prompts, wherein each text prompt comprises a request for data stored in the database, and wherein the recursive prompt comprises previously retrieved data;
transmitting the recursive prompt to the model serving system;
receiving generated text prompts from the model serving system; and
retrieving data from the database based on the generated text prompts;
responsive to determining that an end condition is met, ending the repeated retrieval of data from the database;
generating a final prompt based on the retrieved data from the database and the received analysis prompt, wherein the final prompt comprises text requesting that the model serving system generate the requested analytics;
receiving an analysis response from the model serving system comprising the requested analytics; and
transmitting the analysis response to the client device for display to the user.

12. The computer-readable medium of claim 11, wherein receiving the analysis prompt comprises:
receiving the analysis prompt through a user interface of a client application operating on the client device of the user.

13. The computer-readable medium of claim 12, wherein receiving the analysis prompt comprises:
receiving the analysis prompt through a chatbot interface of the user interface.

14. The computer-readable medium of claim 11, wherein the user and the database are associated with a third-party entity that is associated with data stored in the database.

15. The computer-readable medium of claim 11, wherein the recursive prompt comprises a role indicator indicating a real-world perspective for generating text prompts.

16. The computer-readable medium of claim 11, wherein retrieving data from the database based on the generated text prompts comprises:
generating a database query for each of the generated text prompts.

17. The computer-readable medium of claim 16, wherein generating a database query for each of the generated text prompts comprises:
accessing a set of prompt examples stored by the online system, wherein each prompt example comprises:
a free text prompt describing a request for data stored by the online system in a database; and
a database query to retrieve the data stored by the online system from the database;
generating a prompt example embedding for each prompt example of the set of prompt examples based on the free text prompt of the prompt example; and
for each of the generated text prompts:
generating a prompt embedding for the generated text prompts, wherein the prompt embedding for the generated text prompt is in the same latent space as the prompt example embeddings;
identifying prompt examples that are similar to the generated text prompt based on the prompt example embeddings and the prompt embedding for the generated text prompt;
transmitting a structured prompt to a model serving system, wherein the structured prompt comprises the generated text prompt and the database queries corresponding to the identified prompt example embeddings; and
receiving, from the model serving system, a generated database query corresponding to the generated text prompt, wherein the generated database query is a query for collecting data from the database that was requested by the generated text prompt.

18. The computer-readable medium of claim 11, wherein determining that the end condition is met comprises:
receiving a stop instruction from the client device of the user.

19. The computer-readable medium of claim 11, wherein determining that the end condition is met comprises:
determining that the repeated retrieval of data from the database has been performed a threshold number of times.

20. The computer-readable medium of claim 11, wherein the model serving system is a third-party system.
